(19) United States
(12) Patent Application Publication
(10) Pub. No.: US 2006/0097590 A1
(43) Pub. Date: May 11, 2006

(54) Electric machine, in particular a direct current motor

(76) Inventor: Jurgen Schill, Bad Durrheim (DE)

Correspondence Address: Mark C. Comtois;DUANE MORRIS LLP, Suite 700, 1667 K Street, N.W., Washington, DC, 20006, US

(21) Appl. No.: 11/225,123

(22) Filed: Sep. 14, 2005

(30) Foreign Application Priority Data
Oct. 15, 2004 (DE) 10 2004 050 374.5

(51) Int. Cl. H02K 11/00

(52) U.S. Cl. 310/71

(57) ABSTRACT

An electric machine, in particular a DC motor having a stator that carries windings which are connected to each other for the control of the machine, each phase of the machine comprising at least one winding, and having a connector device to connect the windings, the connector device having a plurality of connector rings that are disposed at one end face of the stator coaxial to the stator, the number of connector rings being at least as great as the number of phases so that each winding belonging to one phase is connected to an associated connector ring.

### FIELD OF THE INVENTION

The invention relates to an electric machine, and in particular a DC motor, having a stator that carries windings which are electrically connected to each other for the control of the machine.

A preferred field of application for the invention is in brushless DC motors and other permanent magnet motors that can be configured as inner rotor motors or as outer rotor motors.

### BACKGROUND OF THE INVENTION

DC motors having an inner rotor motor configuration have a rotor back yoke that is mounted onto a shaft and carries one or more permanent magnets. The permanent magnets are mounted onto the rotor back yoke or embedded in the back yoke. The rotor is enclosed by a stator that generally comprises a stator body consisting of a number of stacked metal laminations which form an annular stator back yoke from which stator teeth extend radially inwards. The stator teeth form poles between which stator slots to accommodate stator windings are formed. At least one winding is provided for each phase of the motor, wherein the windings of each phase applied about the stator teeth can be connected in parallel or in series. In the case of an inner rotor motor, the rotor arrangement is inserted coaxially into the stator arrangement; for an outer rotor motor configuration, the rotor arrangement conversely encloses the stator co-axially.

In a DC motor to which the invention can be applied, the stator normally consists of a slotted stack of laminations, wherein the windings, as shown, for example, in FIGS. 1a, 1b and 2 can be wound about the stator teeth and connected.

FIG. 1a shows a winding pattern for a nine-slot stator, the windings belonging to one phase being connected in series and the windings being connected in a star connection. FIG. 1b shows a winding pattern for a nine-slot motor, the individual windings belonging to one phase being connected in parallel and the windings being connected in a star connection. FIG. 2 shows a winding pattern for a nine-slot electric motor, the individual windings belonging to one phase being connected in parallel and the windings being connected in a delta connection.

In FIGS. 1a, b and 2 the three phases of the motor are indicated by U (A); V (B); and W (C). The slots formed between the stator teeth are numbered through from 1 to 9. The neutral point of the star connection is indicated by CT in FIGS. 1a and 1b.

It can be clearly seen from FIGS.1a, b and 2 that it is necessary to provide different connection arrangements for the stator windings depending on the wiring of these windings, even if the number of phases and stator slots of the motor remain unchanged.

A brushless DC motor is known from DE 36 07 289 whose windings are connected via a flange ring in the region of an end face of the stator. Strip conductors are held in one plane within the flange ring and the ends of the windings can be connected to the strip conductors via window openings in the flange ring. The strip conductors are made of stamped metal strips and comprise connector tongues leading radially away from the flange ring. In the connection arrangement thus described, for each different method of wiring the motor windings, it is necessary to provide an individually adapted flange ring with strip conductors configured accordingly.

It is the object of the invention to provide an electric machine that has a simple design and construction and does not require different connection arrangements for the various winding patterns of the phase windings.

### SUMMARY OF THE INVENTION

The invention provides an electric machine, and in particular a DC motor, having a stator that carries windings that are connected to each other for the control of the machine. Each phase of the machine comprises at least one winding. According to the invention, a connector device to connect the windings is provided, the connector device having a plurality of connector rings that are disposed at one end face of the stator, coaxial to the stator. The connector rings are arranged at an axial spacing from each other or insulated against each other by some other means. The number of connector rings is as least as great as the number of phases so that each winding belonging to one phase can be connected to an associated connector ring. The connector device for the windings of the electric machine according to the invention can be made up of a plurality of preferably identical connector rings which are punched, for example, from sheet metal. The connector rings are designed such that they are disposed at the end face of the stator coaxial to the stator and offset against each other at a specific angle.

The connector device according to the invention is fabricated as follows. A connector ring is disposed at the end face of the stator and the winding of one phase is soldered onto it according to the winding pattern; then a substantially identical connector ring is disposed on the end face of the stator at a spacing from and coaxial to the first connector ring, but offset at a specific angle, and the winding of the next phase of the machine is soldered to this second connector ring, and so forth. The invention has the advantage that only a number of identical connector rings are needed to connect and wire up the motor windings, the connector rings having a simple structure and, due to the substantial number of identical components, being cost-effective to manufacture.

When the windings of the electric machine are interconnected in a star connection, the number of connector rings is preferably the same as the number of phases of the machine plus one (1). In this configuration, a connector ring for connection to the neutral point of the star connection is provided, allowing the neutral point to be led to the outside. In an alternative configuration, the windings can be interconnected at their neutral point directly within the motor, so that the neutral point is not led to the outside via a connector ring. In this configuration, the number of connector rings is the same as the number of phases, i.e. three (3). When the windings are connected in a delta connection, the number of connector rings is preferably the same as the number of phases, i.e. three (3).

According to the invention, the connector rings are preferably made as stamped sheet metal parts. This has the advantage that only one single, very simple punching tool is needed to manufacture the connector device made up of a plurality of rings. The sheet metal should be made of a metal that has good conducting and welding properties, such as a Cu-alloy, to ensure low line losses and to allow the winding ends to be easily soldered to the connector rings.

In a preferred embodiment of the invention the connector rings have projections on their outside surface that extend in a radial direction and are used to position the connector rings. These projections can interact with corresponding recesses in an inside wall of the housing in order to position the connector rings with respect to the housing and to keep them in the correct position. To ensure that the connector rings are bedded in the recesses in a mechanically stable way, three such projections are preferably provided on the outside surface of the connector rings. It is expedient if the number of recesses in the inside wall of the housing to receive these projections corresponds to the number of stator slots. The number and arrangement of the projections and the corresponding recess used to position the connector rings should be properly chosen so that the connector rings can be adjusted to any rotational position desired.

In another preferred embodiment of the invention, each connector ring has a terminal lug on its outside surface for the purpose of connecting a power supply for the machine. This terminal lug extends in an axial direction to the machine, perpendicular to the plane of the connector rings, and can be so designed that it projects directly from the machine in the form of a contact plug.

The connector rings can further have projections on their inside surface to affix winding ends, the projections extending in a radial direction. This goes to simplify the connection between the winding ends and the connector rings. The number of these projections is preferably the same as the number of stator slots.

### SHORT DESCRIPTION OF THE DRAWINGS

The invention is described in more detail below on the basis of preferred embodiments with reference to the drawings. The figures show:

FIG. 1a a winding pattern of a nine-slot DC motor whose phases are connected in a star connection, the windings belonging to one phase being connected in series;

FIG. 1b a winding pattern of a nine-slot DC motor whose phases are connected in a star connection, the windings belonging to one phase being connected in parallel;

FIG. 2 a winding pattern of a nine-slot DC motor whose phases are connected in a delta connection, the windings belonging to one phase being connected in parallel;

FIG. 3 a schematic perspective view of a stator body according to the prior art;

FIG. 4a a view from above of a connector ring according to the invention;

FIG. 4b a side view of the connector ring of FIG. 4a;

FIG. 5 a sectional view through an electric machine according to the invention in which only the stator, a housing and the connector device are shown;

FIG. 6 an exploded, perspective view of the electric machine according to FIG. 5;

FIG. 7 a perspective view of the electric machine of FIG. 5 in an assembled state; and

FIG. 8 an exploded, perspective view of a complete DC motor according to the invention.

### DETAILED DESCRIPTION OF PREFERRED EMBODIMENTS

The invention is described below using a nine-slot DC motor as an example, the person skilled in the art being aware that the invention is not limited to the details described.

FIG. 3 shows a perspective view of a stator body according to the prior art as can also be used in the machine according to the invention. The stator body 110 comprises a back yoke ring 112 and stator teeth 114 projecting radially inwards from the back yoke ring 112. Stator slots 116 are formed between the stator teeth 114, the stator slots receiving the stator windings (not illustrated in the figure) that are wound about the stator teeth 114.

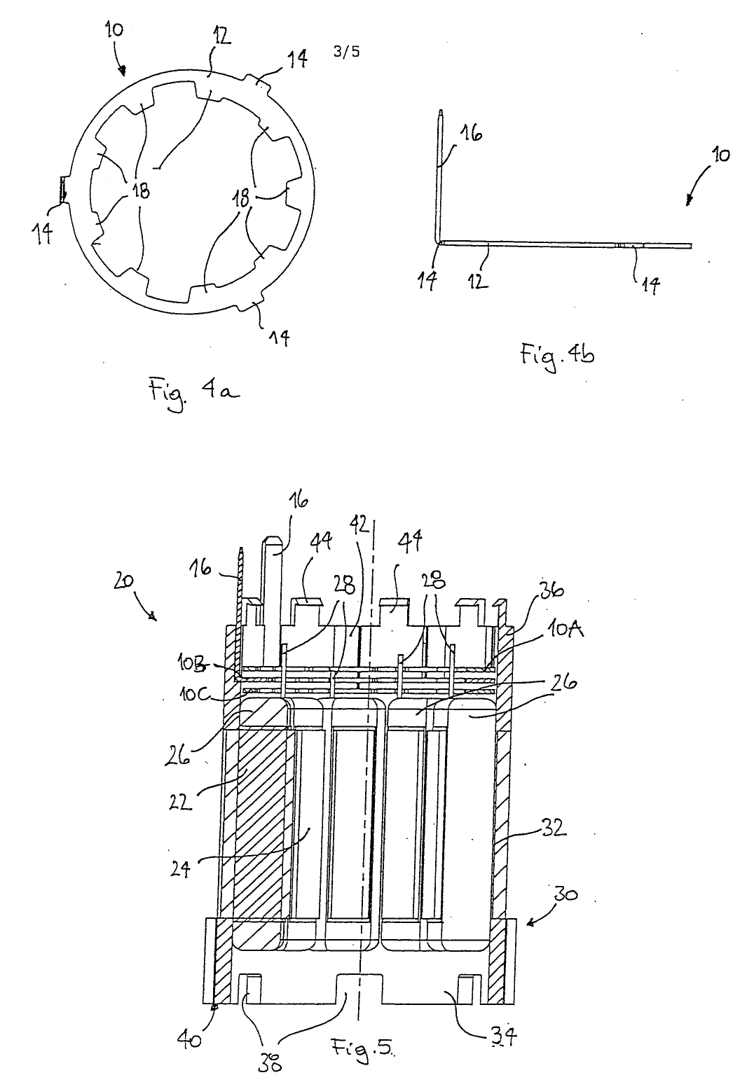

As is apparent when FIGS. 3 and 4a are compared, the number of projections 18 on the inside surface of the connector ring 10 corresponds to the number of slots 116 of the stator 110, which, in this example, is intended for a nine-slot DC motor. According to the invention, a plurality of connector rings 10 are disposed at an end face of the stator, arranged coaxially with a spacing between them, in order to connect the windings of the individual motor phases. Here, various connecting arrangements, in particular a delta and star connection, as well as connection in series and in parallel of the individual winding sections belonging to one phase can be realized with the aid of identical connector rings 10.

FIGS. 4a and 4b show a view from above and a side view of a connector ring 10 that forms a part of a connector device according to the invention. The connector ring 10 comprises an annular body 12 from whose outside surface three projections 14 protrude in a radial direction, the projections being used to position the connector ring 10, as explained in more detail below. One of the projections 14 turns into a terminal lug 16 that extends perpendicular to the plane of the body 12 of the connector ring. The terminal lug 16 is used to connect a power supply for the electric machine, as described in more detail below. Projections 18 that are used to affix winding ends are formed on the inside wall of the annular body 12. In a preferred embodiment of the invention, the number of projections 18 on the inside surface of the connector ring 10 corresponds to the number of slots of the electric motor, as explained in more detail below. In the example illustrated in FIGS. 4a and 4b, a connector ring 10 for a nine-slot electric motor is shown. An associated (unwound) stator for a motor of this kind is illustrated FIG. 3.

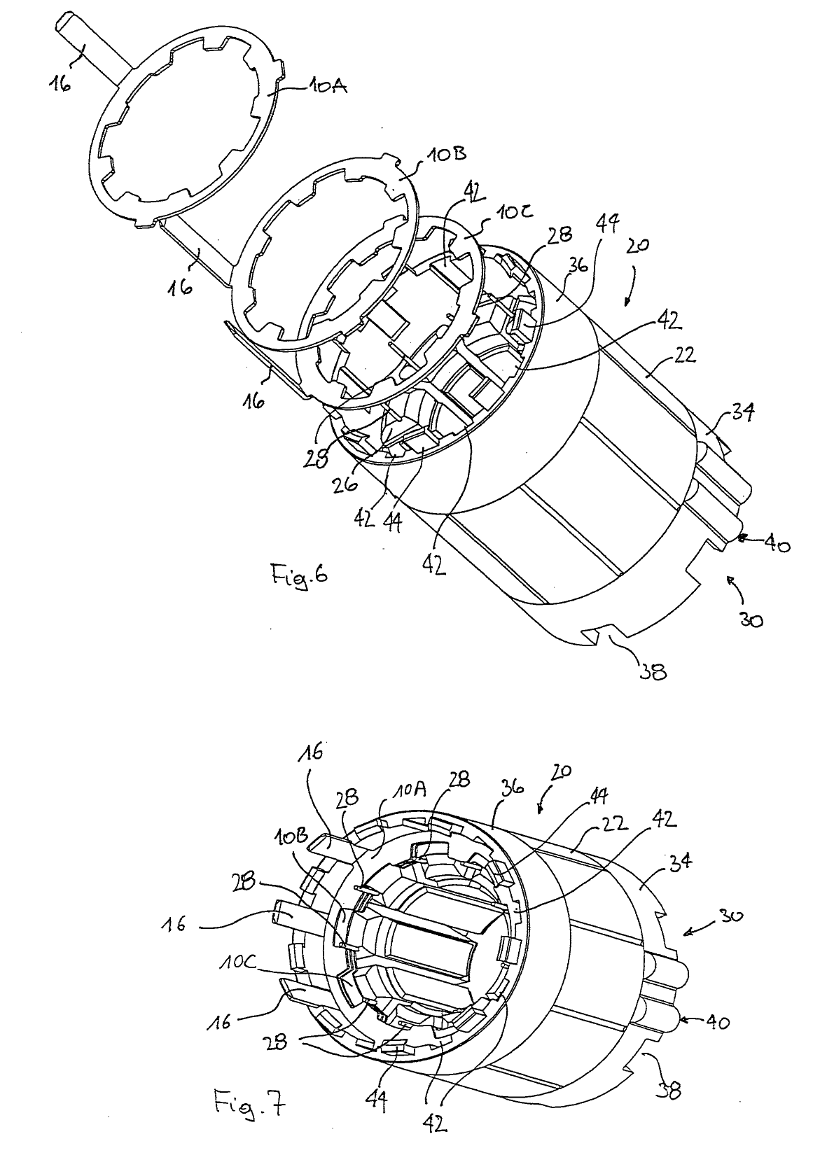

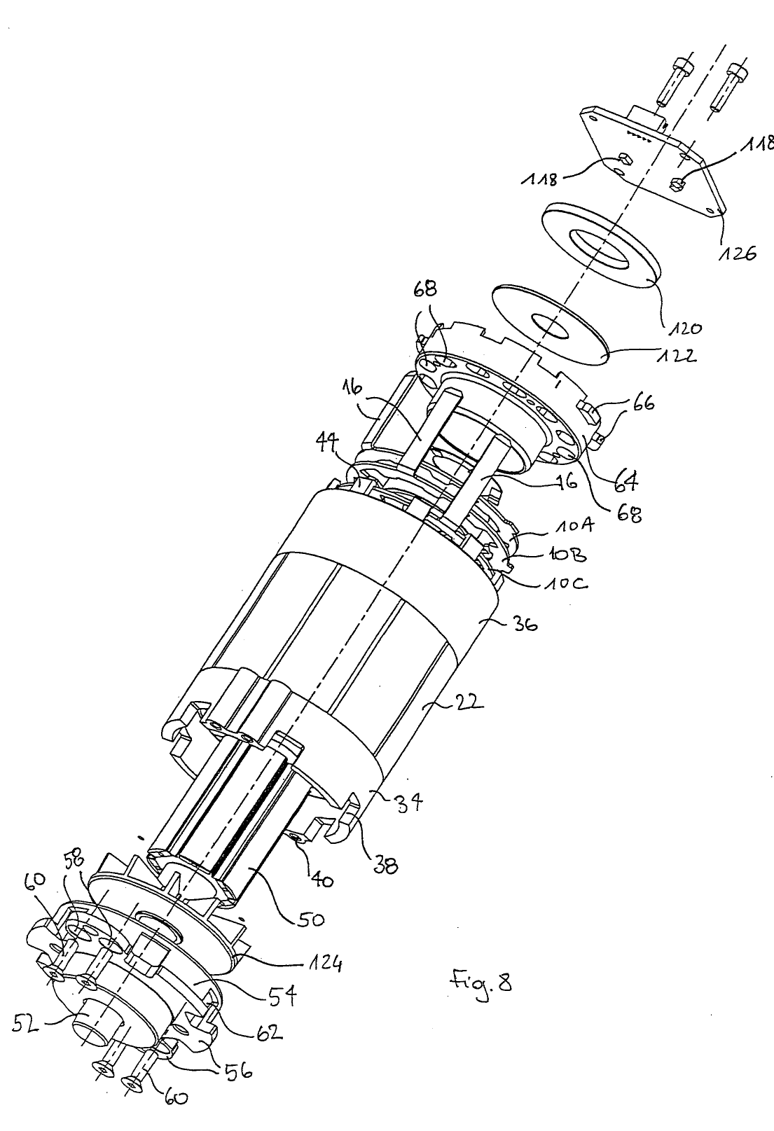

FIG. 5 shows a sectional view through a DC motor according to the invention, the rotor and the end flange of the motor being left out for the sake of clarity. FIGS. 6 and 7 show perspective views of the electric motor illustrated in FIG. 5, the connector rings being shown in FIG. 6 in an exploded view and in FIG. 7 in an assembled state.

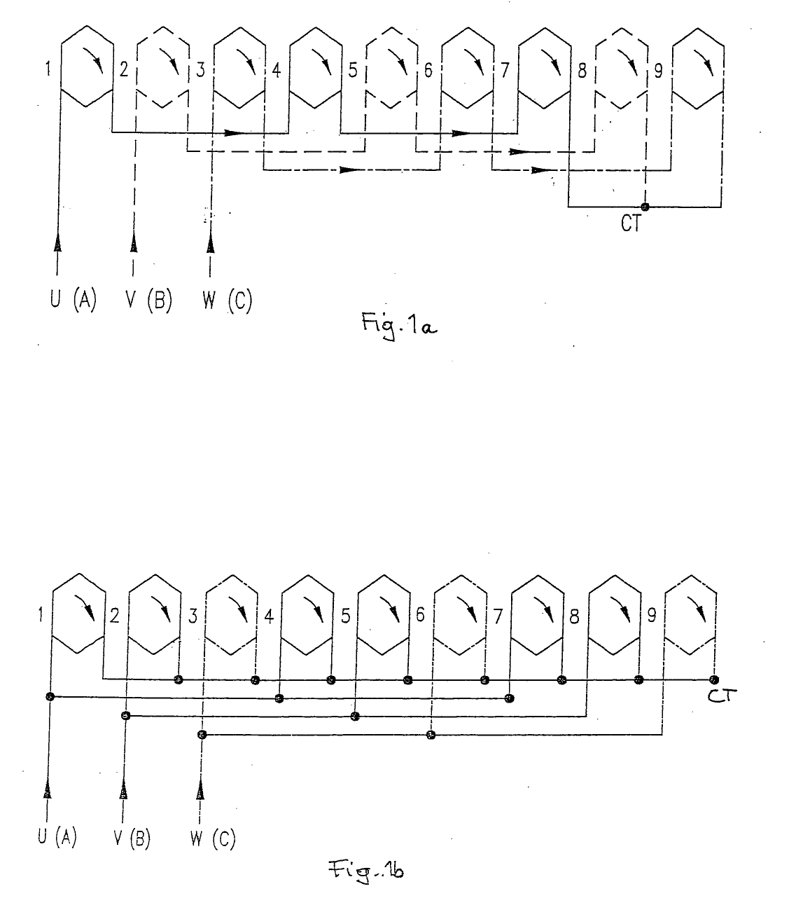

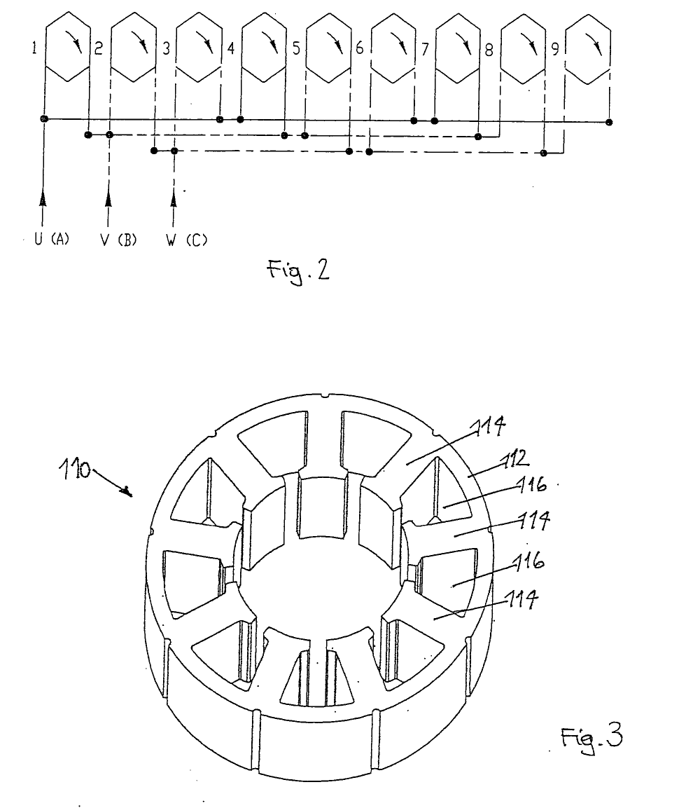

The DC motor 20 comprises a stator 22 which can be designed as shown in FIG. 3. The stator 22 is built up, for example, from a slotted stack of laminations, the stator teeth 24 defining the stator slots. Windings 26 are wound onto the stator 22 about the stator teeth 24, wherein the winding pattern can correspond to one of the winding patterns shown in FIGS. 1a, 1b and 2, but is not limited to these. In the following, it is assumed that the windings 26 in this example are connected together in a delta connection which is shown, for example, in FIG. 2. Three connector rings 10A, 10B, 10C which are associated with the three phases U (A), V (B) and W (C) of the DC motor are disposed at an end face of the stator 22. The connector rings 10A, 10B, 10C are arranged coaxial to the stator 22 with a spacing between one another. The connector rings 10A, 10B, 10C are preferably designed like the connector ring 10 shown in FIGS. 4a and 4b, having inner projections 18 to connect winding ends and outer projections 14 to position the connector rings, as well as terminal lugs 16.

The winding ends 28 of the windings 26 are soldered to the inner projections 18 in accordance with the winding pattern shown in FIG. 2. Each of the connector rings 10A, l0B, l0C thus provides contact points for one of the phases U (A), V (B), W (C) of the DC motor, the winding ends being connected to the associated connector rings in various configurations according to the winding pattern. Should the windings of the DC motor be connected together in a star connection, an additional connector ring can be provided as a contact for the neutral point. This extra connector ring can be designed like the connector ring 10 shown in FIGS. 4a and 4b, it not being necessary, however, to provide the terminal lug 16 for this connector ring.

The connector rings 10A, 10B, 10C are disposed on the DC motor such that the terminal lugs 16 are used as contact plugs which project from a motor housing for the purpose of controlling the motor from the outside.

In the embodiment of the DC motor according to the invention shown in FIGS. 5 to 7, a housing member 30, preferably made of plastics, is formed on the stator 22, the housing member comprising an insulating layer 32 in the stator slots and end housing sections 34, 36.

The housing member 30 is designed so that the two end housing sections 34, 36 are substantially aligned with the outside surface of the stator 22 and directly adjoin the stator. In this way, the stator 22 together with the housing member 30 forms a single unit closed to the outside, making an additional housing that encloses the entire motor unnecessary. Recesses 38 and holes 40 are formed in housing section 34 that are used to position and fasten an A-flange which is associated with the drive side, as explained in more detail with reference to FIG. 8.

At the opposing housing section 36, associated with the control of the DC motor, recesses 42 are likewise formed in the inside wall of housing section 36, the recesses being used to position the connector rings 10A, 10B, 10C. In a preferred embodiment of the invention, the number of recesses 42 in the inside wall of the housing section 36 corresponds to the number of slots of the DC motor—nine in the illustrated embodiment—so that the connector rings 10A, 10B, 10C can be offset against each other at an angle α which corresponds to α=

$$\frac{360 °}{Number of slots}$$

or an integral multiple thereof. This makes it possible to position the connector rings 10A, 10B, 10C in such a way that the associated winding ends 28 can be easily soldered onto the inner projections 18 and the terminal lugs 16 can be arranged as required adjacent to one another or evenly distributed about the circumference of the motor.

A set of three recesses 42 is provided to receive each connector ring 10A, 10B or 10C. The three triple sets of recesses are formed in an axial direction in housing section 36 with differing depths, so that the connector rings 10A, 10B, 10C can be positioned on different planes. This makes it possible to arrange the connector rings 10A, 10B, 10C at an axial spacing from each other without needing to provide any extra insulation between the rings. In the illustrated embodiment, each set of three recesses, associated with a connector ring 10A, 10B or 10C, contains three recesses 42, offset by 120°, of the same axial length measured from the outside edge of housing section 36, this axial length, however, being different to the length of the two other sets of three recesses in which the two other connector rings are placed.

Housing section 36 further has locking lugs 44 that interact with a B-flange on this end face of the DC motor which again will become more apparent with reference to FIG. 8.

FIG. 8 shows an exploded perspective view of a DC motor according to the invention. Parts corresponding to those in FIGS. 5 to 7 are indicated by the same reference numbers.

A rotor 50 that is mounted onto a shaft 52 is coaxially inserted into the stator 22. An A-flange 54 is disposed at the drive side of the motor (the lower end in the figure) that is located at housing section 34, the A-flange having holes 58 in flange sections 56 which are brought into line with the holes 40 in the housing section 34. The A-flange 54 can be connected to the housing section 34 by means of screws 60, rivets or similar connecting elements through the holes 58, 40. In the illustrated embodiment, the A-flange 54 has recesses 62 on its circumference which are aligned with the recesses 38 on the housing section 34. The recesses 62, 38 act as ventilation slits to admit air which is moved using a fan wheel 124, in order to ventilate and cool the DC motor.

At the opposite end of the DC motor from the drive side, at housing section 36, three connector rings 10A, 10B, 10C are illustrated that act as a contact for the phase windings of the electric motor (not illustrated in this figure). The connector rings 10A, 10B, 10C have terminal lugs 56 which project from the housing after the DC motor has been assembled and are used to connect a power supply or for the control of the motor. At this end face, the DC motor is closed by a cover or a B-flange 64, the B-flange 64 having projections 66 which act as a height-stop for the flange 64 on the housing member 30. After the connector rings 10A, 10B, 10C and the B-flange 64 have been mounted onto the housing section 36, they are held there using the locking lugs 44. The B-flange 64 has openings 68 to suck in the air used for ventilation.

The terminal lugs 16 are led to the outside along the outside of the flange 64.

On the power supply side, the DC motor is closed by a circuit board 126. Hall sensors or other magnetic sensors 118 are mounted on the circuit board 126 to measure the rotational position of the rotor 50. The magnetic sensors 118 interact with a control magnet 120 that is mounted on a magnetic back yoke ring 122 and fixedly connected to the shaft 52 in order to generate the commutation signals necessary for the control of the electric motor. The control magnet 120 is disposed on the side of the ferromagnetic back yoke ring 122 facing the magnetic sensors so that the magnetic sensors and the control magnet face each other.

The connector device according to the invention provides an electric machine, in which different winding patterns can be easily connected in a delta or star connection, in series or in parallel, without it being necessary to change the connector device. The wiring of the windings is realized in that first a connector ring is placed in the housing, the windings of one phase are soldered to the connector ring as required and then an identical connector ring is offset at a specific angle and inserted at an axial spacing and the windings of the next phase are soldered to this second connector ring. This is repeated for the third connector ring. If the phases are to be connected together in a star connection, an extra connector ring can be provided for the neutral point. Only a simple punching tool is needed to produce the connector device according to the invention because all the connector rings are preferably identical in design. The insertion and fastening of the connector rings is made particularly simple through the described construction of the housing member. Due to the axial spacing between the connector rings, no other measures to insulate the connector rings need be taken.

The characteristics revealed in the above description, the claims and the figures can be important for the realization of the invention in its various embodiments both individually and in any combination whatsoever.

1. An electric machine, in particular a DC motor having a stator (22) that carries windings (26) which are connected to each other for the control of the machine, each phase of the machine comprising at least one winding (26), and having a connector device to connect the windings (26), the connector device having a plurality of connector rings (10A, 10B, 10C) that are disposed at one end face of the stator (22) coaxial to the stator, the number of connector rings (10A, 10B, 10C) being at least as great as the number of phases so that each winding (26) belonging to one phase is connected to an associated connector ring (10A, 10B, 10C).

2. A machine according to claim 1, wherein the windings (26) are connected in a star connection and the number of connector rings (10A, 10B, 10C) corresponds to the number of phases plus one (1), one of the connector rings (10A, 10B, 10C) being provided for connection to the neutral point of the star connection.

3. A machine according to claim 1, wherein the windings (26) are connected in a delta connection and the number of connector rings (10A, l0B, l0C) corresponds to the number of phases.

4. A machine according to claim 1, wherein the connector rings (10A, 10B, 10C) are substantially identical.

5. A machine according to claim 1, wherein the connector rings (10A, 10B, 10C) are made from stamped sheet metal.

6. A machine according to claim 1, wherein the connector rings (10A, 10B, 10C) are made of a metal that has good conducting and welding properties, such as a Cu-alloy.

7. A machine according to claim 1, wherein the connector rings (10A, 10B, 10C) have projections (14) on their outside surface used to position the connector rings (10A, 10B, 10C), the projections extending in a radial direction.

8. A machine according to claim 7, wherein the projections (14) used for positioning purposes are provided on each connector ring (10A, 10B, 10C).

9. A machine according to claim 1, wherein the connector rings (10A, l0B, l0C) have terminal lugs (16) on their outside surfaces for the purpose of connecting a power supply for the machine, the terminal lugs extending in an axial direction, perpendicular to the plane of the connector rings (10A, 10B, 10C).

10. A machine according to claim 1, wherein the connector rings (10A, 10B, 10C) have projections (18) on their inside surface to affix winding ends (28), the projections extending in a radial direction.

11. A machine according to claim 1, wherein the stator (22) is accommodated in a housing (30) that has means (42, 44) for the positioning and fastening of the connector rings.

12. A machine according to claim 1, wherein the stator (22) has a stator back yoke and stator teeth (24) that project radially inwards or outwards from the stator back yoke, stator slots being formed between the stator teeth to receive the windings (26).

13. A machine according to claim 10, wherein the number of projections (18) to affix the winding ends corresponds to the number of stator slots.

14. A machine according to claim 7, wherein recesses (42) are formed on an inside wall of the housing (30), the recesses interacting with the projections (14) on the outside surface of the connector rings (10A, 10B, 10C) for the purpose of positioning the connector rings (10A, 10B, 10C), the number of recesses (42) corresponding to the number of stator slots.

15. A machine according to claim 14, wherein the recesses (42) that are associated with one connector ring (10A, 10B or 10C) have the same axial depth and that this axial depth is different from the axial depth of the recesses associated with the other connector rings, so that the connector rings (10A, 10B, 10C) are spaced apart from each other in an axial direction.

16. A machine according to claim 1, wherein the connector rings (10A, 10B, 10C) are offset against each other at an angle.
